(19) United States
(12) Patent Application Publication
(10) Pub. No.: US 2026/0225324 A1
(43) Pub. Date: Aug. 6, 2026

(54) PLASTIC STORAGE BAG AND METHOD OF MANUFACTURING SAME

(71) Applicant: DANIEL TAN, HARAHAN, LA (US)

(72) Inventor: DANIEL TAN, HARAHAN, LA (US)

(21) Appl. No.: 19/047,109

(22) Filed: Feb. 6, 2025

(51) Int. Cl. B29C 65/00; B29L 31/00; B65D 33/08

(52) U.S. Cl. CPC B29C 66/43121; B65D 33/08; B29L 2031/7129

(57) ABSTRACT

A plastic bag comprising a front wall, a back wall, a bottom gusset and a top gusset joined together at seams on opposing sides of the bag. The top gusset contains a slit providing an opening to the bag separating a front double film portion and an opposing back double film portion. The top edge of the back double film portion extends above the top edge of the front double film portion to aid in the opening of the bag. Furthermore, a reinforced handle is formed by aligned apertures extending through the front double film portion and the back double film portion.

### FIELD

The present invention relates in general to thermoplastic storage and carrying bags.

### BACKGROUND

Thermoplastic bags or film bags are commonly used in department stores, grocery stores, and restaurants. These bags have advantages in that they are relatively inexpensive to produce but are durable and provide substantial carrying capacity. Plastic bags known in the art generally consists of a single layer (or film) with a set of handles either extending from the bag portion (e.g. a “T-shirt” bag) or a cut-out handle included in the bag portion itself (commonly known as a “Merchant” bag). One method for manufacturing these bags involves flattening a continuous tube of plastic film, such as a thermoplastic film, and then cutting and sealing the individual bags. Optionally, the foregoing method may include a gusseter that is used to add side gussets to the plastic tube, allowing for a greater volume and carrying capacity between the front and back walls of the finished bag.

While the process for manufacturing these bags can be considered streamlined and efficient, there are certain drawbacks to the end product. For example, since these bags are manufactured from a single tube of film, the tensile strength is limited to the strength of thermoplastic material. Often these bags are overloaded, causing the handle to stretch or even fail completely. Additionally, because these bags are flattened and then usually packaged in a stacked configuration, the front and back walls are difficult and cumbersome to separate.

There is a need for a plastic bag that captures all the benefits of existing plastic bags, but also provides a handle that can accommodate heavier loads as well as an improved means for easily opening the bag prior to use.

### BRIEF SUMMARY OF THE INVENTION

It is the object of this invention to provide a plastic bag and method for manufacturing same that can accommodate larger carrying capacities and heavier loads through the inclusion of a reinforced handle as well as an improved means for separating the bag at the top open end.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 is a front view of the plastic bag in accordance with the embodiments of the invention.

FIG. 2 is a back view of the plastic bag in accordance with the embodiments of the invention.

FIG. 3 is a cropped view of the front of the plastic bag in accordance with the embodiments of the invention.

FIG. 4 is a top view of the plastic bag in accordance with the embodiments of the invention, showing the bag in an open configuration with the gusseted bottom portion in a closed position.

FIG. 5 is a top view of the plastic bag in accordance with the embodiments of the invention, showing the bag in an open configuration with the gusseted bottom portion in an open position.

FIG. 6 is a top view of the plastic bag in accordance with the embodiments of the invention, showing the film edge band portion of the handle in a separated configuration.

FIG. 7 is a perspective view of the bottom of the plastic bag showing the gusseted bottom portion in an open position.

FIG. 8 is a cross section through the open plastic bag from top to bottom with the bottom gusset partially opened showing the V shaped gusset and gusset sidewalls.

FIG. 9 is a top view of the plastic bag in accordance with the embodiments of the invention, showing the top gusset in a partially open position before applying the slit.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention. It is contemplated that features of one configuration may be beneficially incorporated in other configurations without further recitation.

### DETAILED DESCRIPTION

For a further understanding of the nature and function of the embodiments, reference should be made to the following detailed description.

The invention provides a plastic storage bag that can be readily manufactured using conventional bag manufacturing equipment at high speeds and low cost.

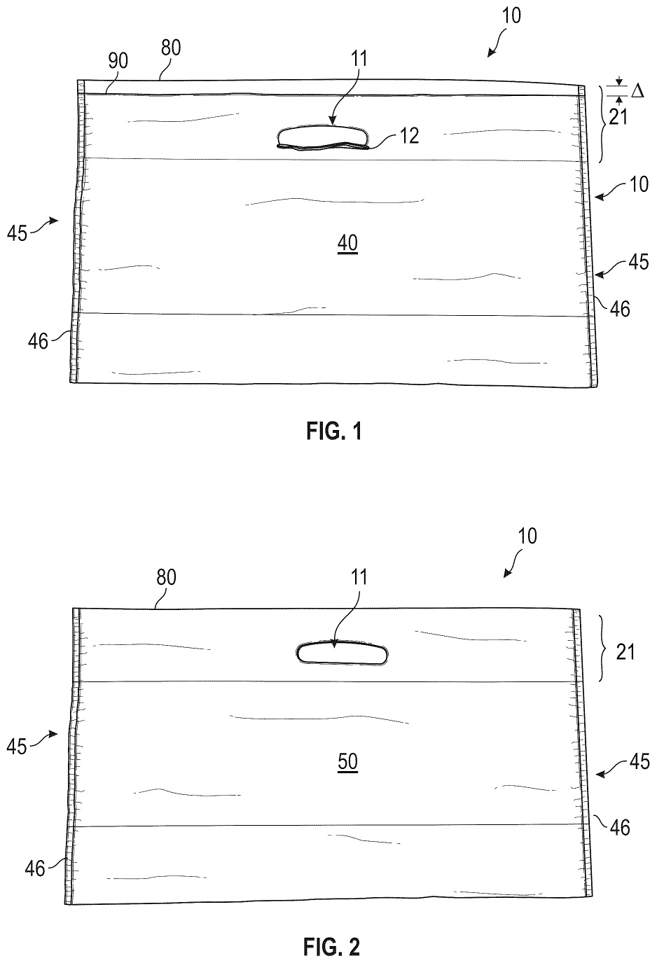

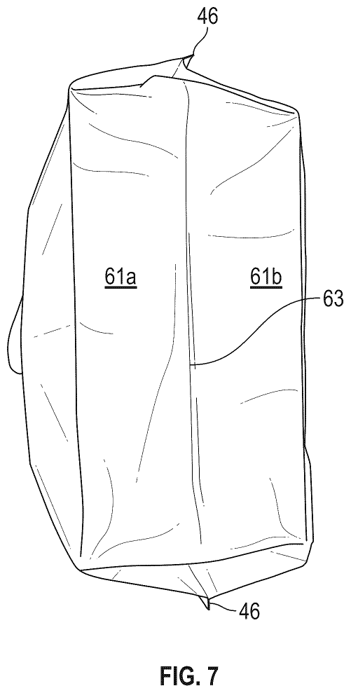

Turning to FIGS. 1-7, a preferred embodiment of the plastic bag 10 in accordance with the invention is shown.

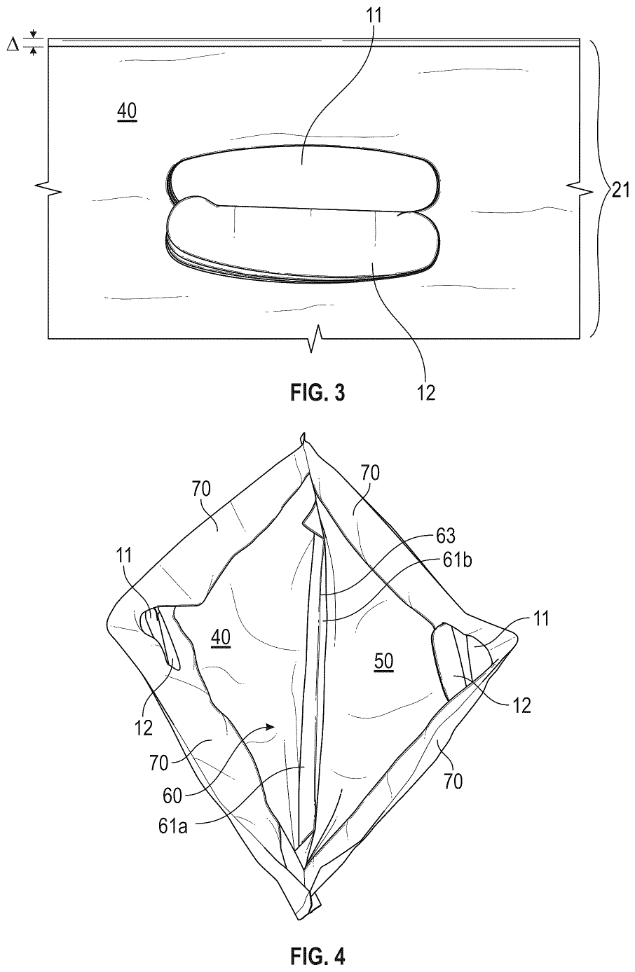

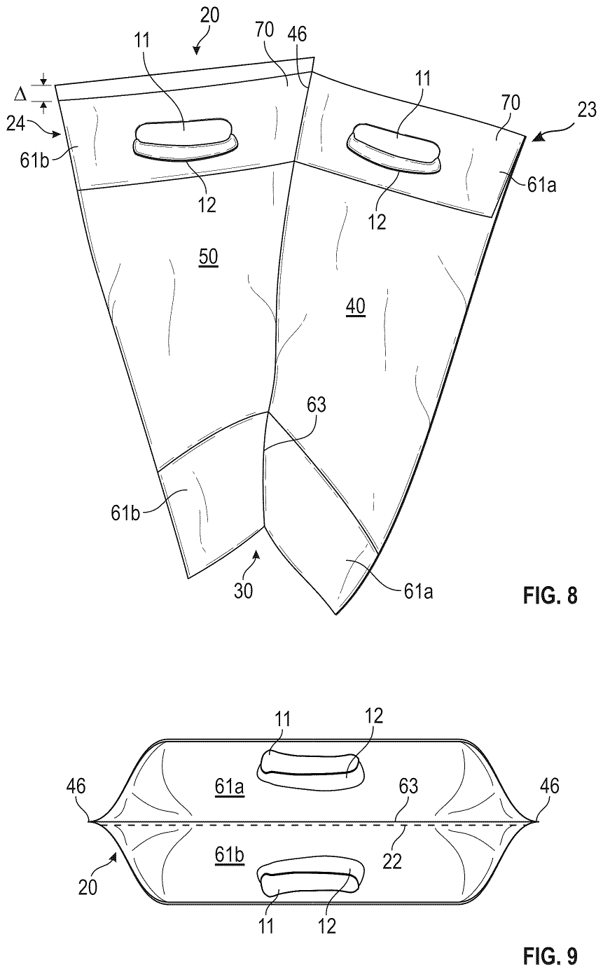

As shown in FIGS. 1-2, the plastic bag 10 is shown in a closed flattened configuration and includes a front wall 40 and back wall 50, a top gusset 20 (see FIG. 9) and a bottom gusset 30 (see FIG. 8) each joining the front 40 and back wall 50. In construction from a continuous tube of plastic film, when flattened, the opposing top and bottom gussets 20,30 are formed on opposing sides of the tube. As shown in FIGS. 8-9, the preferred gussets are V-shaped with two V sidewalls 61a, 61b, with the vertex of the V 63 facing toward the interior center of the bag. However, the top gusset 20 is formed to be slightly misaligned, such that when the tube is flattened with the center of the gussets folding inwardly, the misaligned gusset causes the top edge 80 of the back wall 50 to extend above the top edge 90 of the front wall 40. It is envisioned that the process could be reversed such that the misalignment causes the top edge 90 of the front wall 40 extends above the top edge 80 of the back wall 50. In the configuration shown in FIG. 1 and FIG. 3, the back wall 50 extends above the front wall 40 of the flattened bag by an amount Δ. The flattened tube is cut across the tube at 90 degrees from the tube center axis forming two opposing bag sides 45, and these sides or edges are then sealed (such as heat sealed) closed forming a seam 46 on each side 45. The gussets 20, 30 extend across the entire top and bottom of the bag; hence, the gusset sidewalls adjacent to the side 45 of the bag 10 are also captured in the seams 46.

The flattened bag 10 has handle openings 11 cut through the flattened bag on the bag top section 21 of the flattened bag (shown as a U shaped, rectangular, or oval opening). Thus, handle openings 11 are cut in the front wall 40, the back wall 50, and the two sidewalls 61a and 61b of the V shaped gusset 20. The handle openings 11 form handles for carrying the bag. Every handle opening 11 is aligned when the bag is flattened (the “closed” configuration). Each handle opening 11 in the back wall 50, front wall 40 and two V sidewalls 61a and 61b has an associated covering flap 12 of plastic film, which may be the material partially cut-out from the bag when the handle openings 11 are formed.

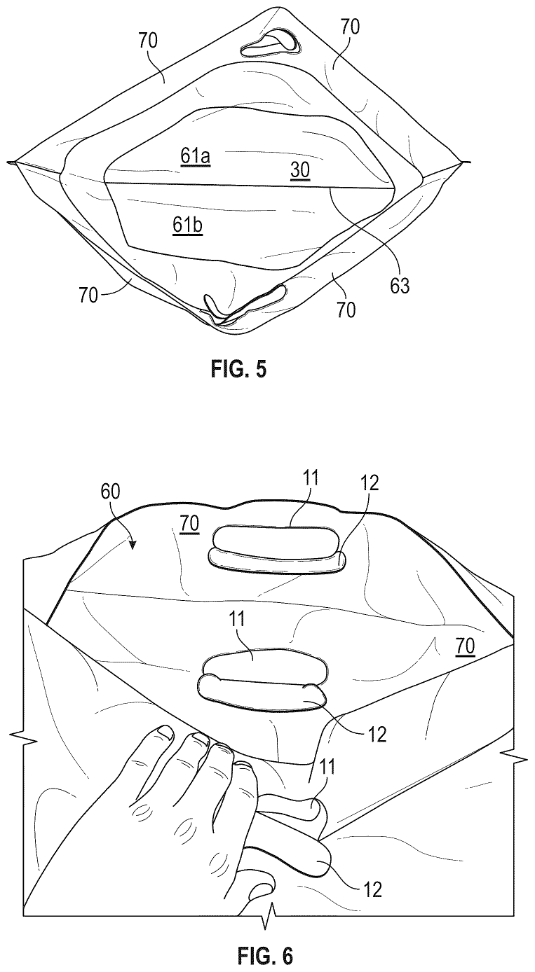

The preferred method of manufacturing the disclosed gusseted portions 20,30 is commonly associated with the process for creating “side gussets” for T-shirt bags and other plastic bags from a single tube of blown plastic film. See e.g. U.S. Pat. Nos. 3,924,521 and 10,246,224, which are hereby incorporated by reference. However, for the disclosed invention, these “side gussets” in prior art bags form the top gusset 20 and bottom gusset 30 of the disclosed plastic bag 10. As shown in FIG. 9, the crease or vertex 63 of the top gusset 20 is then broken such as having a slit 22 cut through the top gusset 20 between the two opposing seams 46 and parallel to the front wall 40 in the closed configuration. The slit 22 (as depicted by the dashed line in FIG. 9) is cut through the vertex of the top V gusset 63. The slit 22 provides an opening 60 into the bag interior and access to the bag interior in the open configuration, as shown in FIGS. 4-5. When the bag is formed from a tubular film of plastic, before the slit 22 is cut in the top gusset 20, the bag front wall 40, back wall 50, bottom gusset 30 and top gusset 20 are a single continuous film of plastic, with the only seams in the bag 10 being the opposing side seams 46.

The slit 22 across the top gusset 20 cuts across the gusset preferably along the vertex 63 between the opposing seams 46, and the top slitted gusset forms a circumferential band 70 of plastic film material around the interior at the top edges of the bag walls 80, 90. See FIGS. 4-5 and FIG. 8. The portion of the circumferential band 70 aligned with the front wall form a front double film portion 23, and the portion of the circumferential band 70 aligned with the back wall 50 form a back double film portion 24. The handle openings 11 cut in each sidewall 61a, 61b of the top gusset 20 remain aligned with the handle apertures (or openings) 11 on the front wall 40 and back wall 50 of the bag. The slitted top gusset 20 and band 70 forms a second layer of plastic film with handle openings 11 cut in the band 70, and the band openings 11 overlaps the handle openings 11 on the front 40 and back 50 walls of the bag 10, thereby reinforcing the handle openings 11 which collectively form the handles of the bag. The band 70 is supported by the front 40 and back 50 walls of the bag as the band 70 is captured in each of the opposing seams 46.

The bag 10 as described reinforces the bag handles by doubling the film thickness in the handle area. The merchant bag as described also assists a user in opening the bag, as the back wall 50 extends above the front wall 40 (or vice versa) such as by 1/16^{th} of an inch, providing an edge offset of the front 40 and back 50 walls that the user can use to open the bag. Additionally, the handle flaps 12 on opposing walls of the bag can assist in opening the bag 10, as opposing flaps 12 on the opposing front 40 and back 50 walls can be grasped and pulled apart, thereby opening the bag.

For the purposes of promoting an understanding of the principles of the invention, reference has been made to the embodiments illustrated in the drawings, and specific language has been used to describe these embodiments. However, this specific language intends no limitation of the scope of the invention, and the invention should be construed to encompass all embodiments that would normally occur to one of ordinary skill in the art. For instance, the gussets can have other shapes, such as W-shaped, and the openings can have different shapes than the U shape described. Other construction methods can also be used, such as manipulating a sheet or sheets of plastic film into the desired configuration. The implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A plastic bag comprising:
a front wall, a back wall, a bottom gusset, and a top gusset joined together at seams on opposing sides of the bag;
wherein the top gusset has a slit therethrough, parallel to a top of the bag and running between the two opposing side seams, the slit providing a central opening separating a front double film portion and an opposing back double film portion,
wherein a top edge of said back double film portion extends above a top edge of said front double film portion when the bag is a closed position.

2. The plastic bag of claim 1, wherein the bottom gusset and the top gusset are V-shaped gussets.

3. The plastic bag of claim 2, wherein the bottom gusset is substantially planar away from the side seams when the bag is in an open position.

4. The plastic bag of claim 1 comprising a handle.

5. The plastic bag of claim 4, wherein said handle is formed from a plurality of aligned apertures extending through the front double film portion and the opposing back double film portion.

6. The plastic bag of claim 5 further comprising one or more flaps extending from the front or back wall.

7. A plastic bag comprising:
a front wall, a back wall, a bottom gusset, and a top gusset joined together at seams on opposing sides of the bag;
wherein the top gusset has a slit therethrough, parallel to a top of the bag and running between the two opposing side seams, the slit providing a central opening separating a front double film portion and an opposing back double film portion,
wherein said front double film portion and said opposing back double film portion comprises a handle formed from a plurality of aligned apertures extending through the front double film portion and an opposing back double film portion.

8. The plastic bag of claim 7, wherein a top edge of said back double film portion extends above a top edge of said front double film portion when the bag is a closed position.

9. The plastic bag of claim 7, wherein the top gusset and bottom gusset are V-shaped gussets.

10. The plastic bag of claim 9, wherein the bottom gusset is substantially planar away from the side seams when the bag is in an open position.

11. The plastic bag of claim 7 further comprising one or more flaps extending from the front or back wall.

12. A method of making a plastic bag, said method comprising the steps of:
providing a tube of plastic;
flattening the tube of plastic;
applying a misaligned gusset to a top section of the flattened plastic tube to form a top gusset comprising a first wall and a second side wall separated by a vertex, wherein a top edge of the second wall is offset from a top edge of the first wall;
applying a gusset to a bottom portion of the flattened plastic tube to form a bottom gusset;
cutting the tube to form opposing sides of the plastic bag;
sealing the opposing sides; and
cutting a slit through the vertex to provide an opening in the plastic bag.

13. The method of claim 12 further comprising the step of cutting aligned openings through the top section of the flattened plastic tube to form a handle.
